(19) United States
(12) Patent Application Publication
(10) Pub. No.: US 2009/0000125 A1
(43) Pub. Date: Jan. 1, 2009

(54) GROOMING TOOL

(75) Inventors: Mark S. Peyser, Easton, CT (US); Abraham D. Schwartz, New Haven, CT (US)

Correspondence Address: Michaud-Duffy Group LLP, 306 Industrial Park Road, Suite 206, Middletown, CT, 06457, US

(73) Assignee: EVEREADY BATTERY COMPANY, INC., St. Louis, MO (US)

(21) Appl. No.: 12/140,378

(22) Filed: Jun. 17, 2008

Related U.S. Application Data
(60) Provisional application No. 60/937,762, filed on Jun. 29, 2007.

(51) Int. Cl. B26B 19/00; B26B 19/28; B26B 21/00

(52) U.S. Cl. 30/34.1; 30/45; 30/526

(57) ABSTRACT

A grooming tool is provided that includes a safety razor assembly adjoined to a hair trimmer assembly. Both assemblies include a housing. The housings may be separable or may be integrally formed. The trimmer assembly includes a motor operably connected to a moving toothed blade. A second toothed blade is removably mounted to the housing of the trimmer. One end of the leaf spring is disposed in a suitably sized recess of the trimmer housing and the opposed second end bears against a driver of the moving blade to maintain sliding contact between the toothed portions of the two blades during operation. When a user removes the second toothed blade, the moving blade may be separately removed while the leaf spring is retained in its recess. Both housings have a width less than 25 mm and the grooming tool is ergonomically familiar to a typical safety razor user.

### CROSS REFERENCE TO RELATED APPLICATIONS

This application claims the benefit of U.S. Provisional Patent Application Ser. No. 60/937,762, filed Jun. 29, 2007.

### BACKGROUND OF THE INVENTION

1. Technical Field

This invention relates generally to grooming devices, and more specifically to safety razors that include a motorized hair trimmer.

2. Background Information

Many safety razors include an elongated hand gripping portion that is ergonomically sized to be comfortably gripped by a user. The gripping portion can be generally straight or include a slight curve. Many of these safety razors have an elongated gripping portion that can be enclosed by a cylinder and/or a portion of a torus both having a diameter in the range from about 10 mm to about 25 mm.

In U.S. Patent application publication 2005/0217115, the disclosure of which is incorporated herein for reference in its entirety, a safety razor handle is provided that includes a motor-driven hair trimmer. Many trimmers, including the devices disclosed in the '115 application include a toothed blade that moves to and fro relative to a second toothed blade. A spring generally provides a force to this moving blade to maintain at least the toothed portions of both blades in sliding contact with each other during normal use to ensure efficient hair trimming. Debris from hair trimming, which can include cut particles of hair and sebum of the hair can become entrapped between the toothed blades leading to a reduction in cutting efficiency. Some trimmers have detachable blade assemblies which can be removed and reinstalled by the user so that the user may clean the blades. However, many of these detachable blade assemblies include in the blade assembly both toothed blades and their respective spring which necessitates a second step of disassembly and subsequent reassembly by the user in order to effectively clean debris from between the blades.

The moving blades in such assemblies can typically be held in place by one or more wire springs. Generally a portion of the spring is affixed to the blade assembly and an end portion of the spring applies the aforementioned force to the moving blade and also moves to and fro with the blade during normal use. In order to accommodate this to and fro movement of the end portion(s) of the spring(s) sufficient space must be provided within the housing of the trimmer.

### SUMMARY

The present invention has for its objective to eliminate, or at least substantially alleviate the limitations of the prior art by providing an improved spring in combination with a trimmer assembly of a safety razor including a trimmer.

In one aspect the present invention resides in a trimmer assembly. The trimmer assembly is adapted to be integrally or detachably mounted to a safety razor assembly. The trimmer assembly includes a housing having a motor disposed within the housing. The trimmer assembly has a toothed moving blade operatively connected to the motor and a toothed lower blade removably mounted to the housing. The trimmer assembly has a leaf spring, a first end portion of the leaf spring is disposed in a recess of the trimmer housing and the opposed end portion acts on a driver part of the moving blade to maintain at least the toothed portions of the blades in sliding contact during normal use. The trimmer housing has a width less than 25 mm and is ergonomically familiar to a safety razor user. When the user removes the lower blade for example for cleaning, the moving blade can be separately removed and the leaf spring is retained in the recess of the housing. In this manner a simple single disassembly step is required if the user, for example, wishes to clean the blades.

In a further aspect, the present invention resides in a grooming tool. The grooming tool has a housing having a safety razor cartridge support assembly at a first end and a trimmer drive assembly at the opposed end. The trimmer drive assembly has a motor, a moving blade, a lower blade and a leaf spring as previously described. The grooming tool housing has a width less than 25 mm and is ergonomically familiar to a safety razor user. As previously described, a simple single disassembly step is required.

The above features and advantages of the present invention will be more fully understood with reference to the following detailed description when taken in conjunction with the accompanying drawings.

### BRIEF DESCRIPTION OF THE DRAWINGS

FIG. 1 is an isometric view of an embodiment of a trimmer assembly of the present invention in combination with a safety razor assembly.

FIG. 2 is an isometric view of an embodiment of a grooming tool of the present invention.

FIG. 3 is a partial sectional view on lines 3-3 of FIG. 1.

FIG. 3A is an enlarged portion of FIG. 3 showing a further embodiment of a trimmer assembly of the present invention.

FIG. 3B is an enlarged portion of FIG. 3 showing a more further embodiment of a trimmer assembly of the present invention.

FIG. 4 is an isometric view of the drive mechanism of the trimmer assembly of FIG. 1 with the housing omitted for clarity of depiction only.

FIG. 4A is an exploded view of FIG. 4.

FIG. 5 is an isometric view of an embodiment of the leaf spring of the present invention.

### DETAILED DESCRIPTION

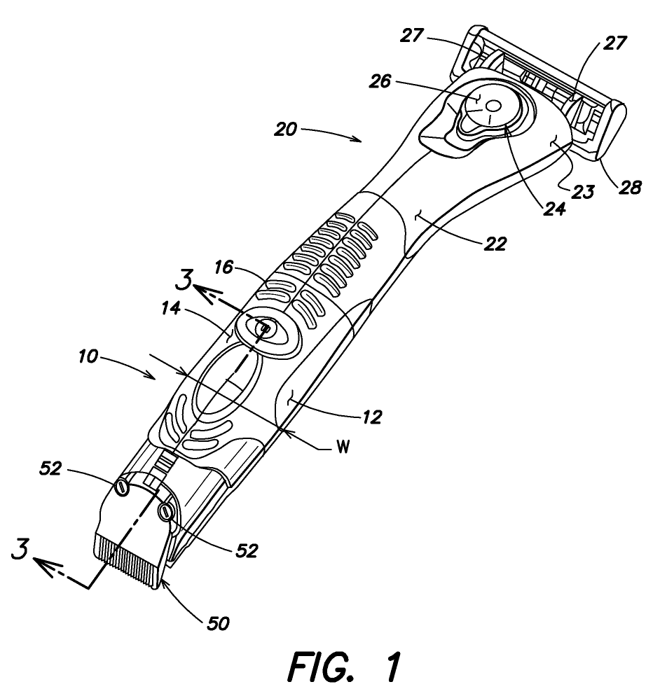

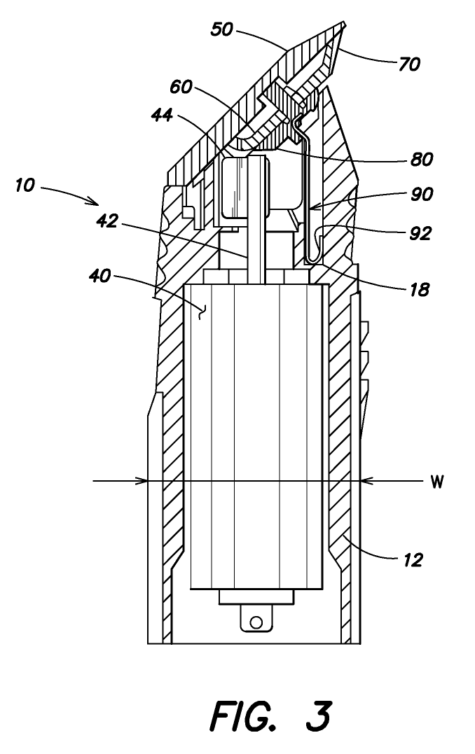

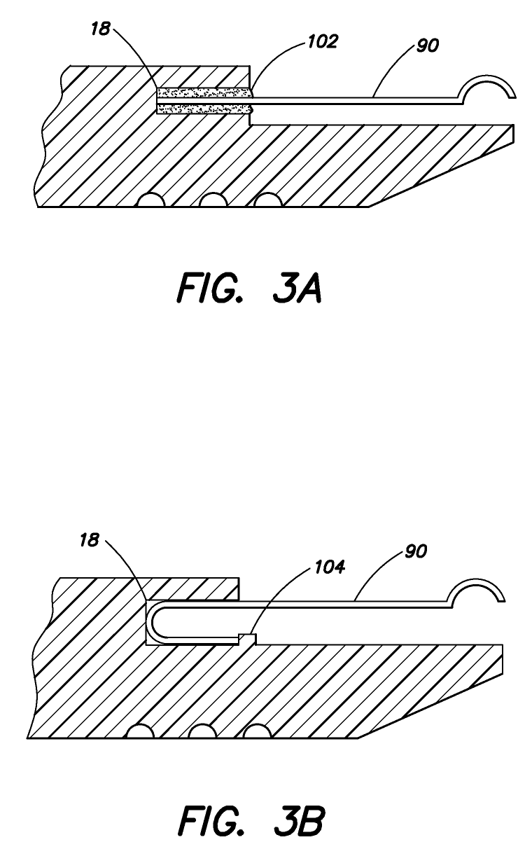

Referring now to the drawings and in particular FIG. 1, a trimmer assembly 10 is shown mounted to a safety razor assembly 20. The trimmer assembly is preferably mounted to the safety razor assembly with a well-known bayonet type arrangement. The trimmer assembly includes an elongated housing 12. The housing has a width W (see also FIG. 3) defined as the side-to-side dimension of the housing in a direction transverse to the direction of elongation of the housing. Width W is defined independently of the orientation of the trimmer assembly (see also FIG. 3). The width excludes any raised ribs 16 that may be added to enhance the real or perceived grip of the housing by a user. The width is preferably less than 25 mm, more preferably less than 23 mm and most preferably less than 20 mm. In this manner the trimmer housing will not be ergonomically unfamiliar to a user of a safety razor. The safety razor assembly also includes an elongated housing 22; a razor cartridge support assembly 24 that includes a user operable cartridge release button 26 and cartridge support arms 27 adapted to receive a razor cartridge 28. The safety razor assembly housing has a width as previously described but can include a locally widened portion 23 that can house part of the cartridge support assembly. Suitable support assemblies and razor cartridges are well known in the art and will not be discussed further in the present application. One or both housings of the trimmer assembly and safety razor assembly can also include resilient gripping pads 14.

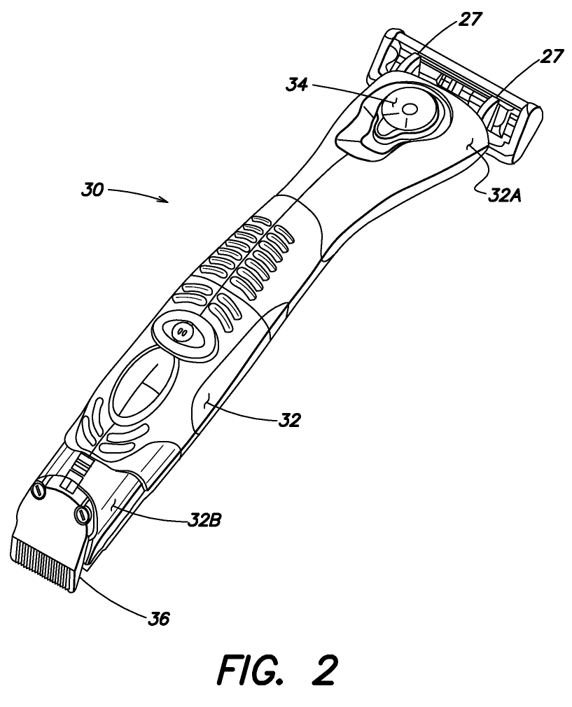

Referring now to FIG. 2 a grooming tool 30 is depicted. The grooming tool includes an elongated housing 32. The housing has a width as previously described and can include a locally widened portion also as previously described. The housing 32 has a safety razor cartridge support assembly 34 disposed at a first end 32A of the housing and a trimmer drive assembly 36 preferably disposed at the opposed end 32B of the housing. The trimmer drive assembly 36 can also be disposed at the same end of the housing as the safety razor cartridge support assembly 34 as for example is disclosed in embodiments of U.S. Patent application publication 2005/0217115, the disclosure of which is incorporated herein for reference in its entirety.

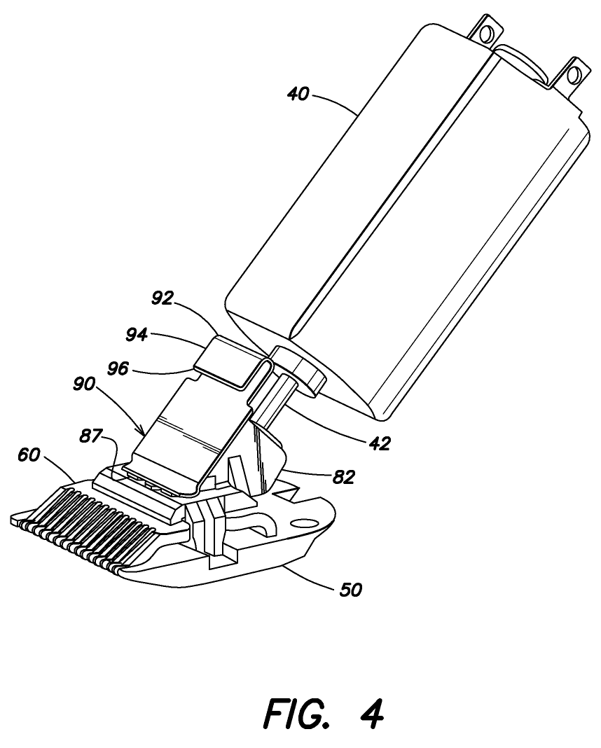

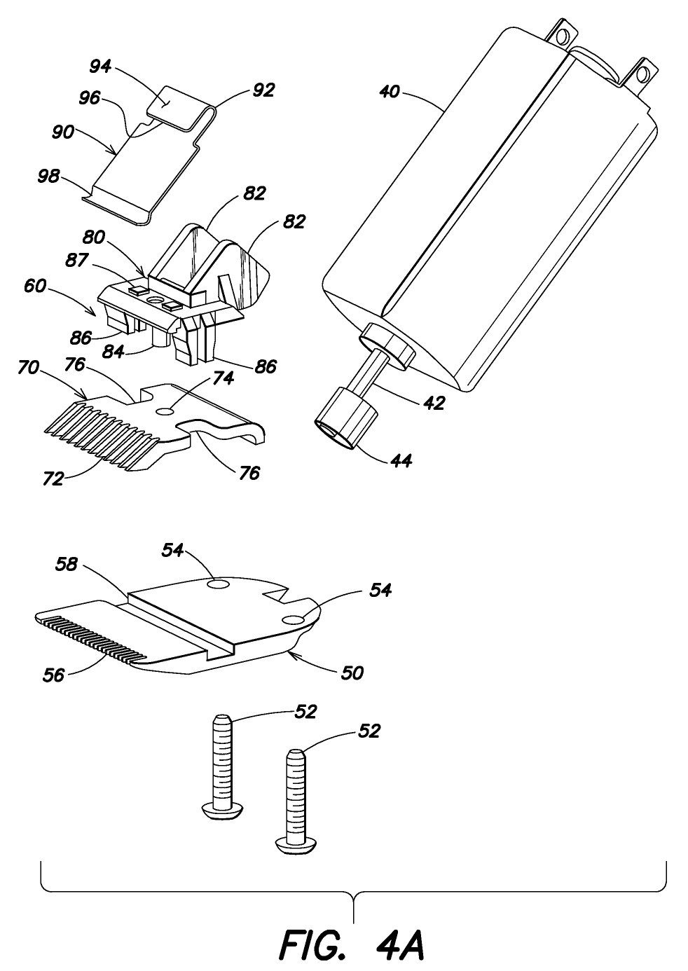

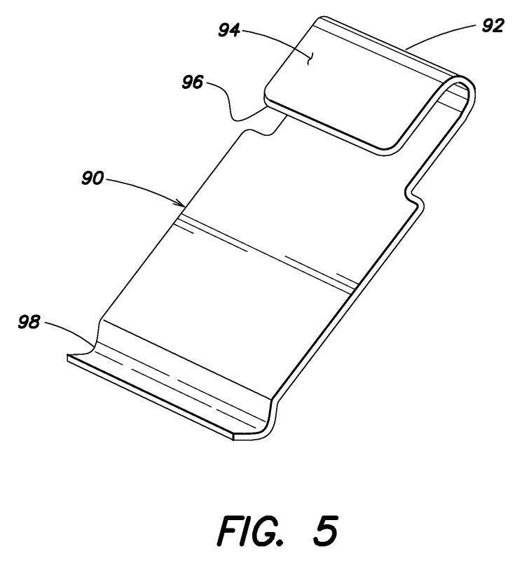

Referring additionally now to FIGS. 3, 4, 4A and 5, the trimmer assembly of FIG. 1 is shown in sectional view (FIG. 3) and isometric views (FIGS. 4 and 4A, FIG. 4A being an exploded depiction of FIG. 4), the latter views have the housing omitted purely for clarity of depiction of internal parts of the trimmer assembly. FIG. 5 shows an isometric view of the leaf spring of the trimmer assembly. The trimmer assembly 10 includes a housing 12. The housing is preferably manufactured by injection molding ABS or polypropylene or die-cast zinc alloy or other suitable material well known to one of skill in the art. Disposed at least partially within the housing is a motor 40, powered by one or more batteries (not shown) or by conventional domestic AC that can be provided via a transformer.

Mounted on the output shaft 42 of the motor is an eccentric 44. The eccentric is preferably manufactured from phosphor-bronze. This material is selected for desirous properties including its bearing characteristics when it moves in contact with the driver 80 in normal use and for its secure press fitting characteristics to the shaft of the motor 42. A lower blade 50, having a toothed arrangement 56 is mounted to the housing preferably by screws 52, the screws passing through holes 54 of the lower blade. The lower blade also has a transverse elongated feature that can include a rib (not shown) or a slot 58. A moving blade 60 includes a cutter part 70 and a driver part 80. The lower blade 50 and cutter 70 are both preferably made from 420 grade stainless steel hardened to 48-52 HRC. One of skill in the art will understand that other materials such as alternate grades of steel or stainless steel may equally be employed as well as ceramic materials and the present invention is not limited in this regard. The driver is preferably manufactured by injection molding a suitable thermoplastic, preferably a so-called engineering grade material and most preferably polyamide 6,6. This material is selected for desirous properties including dimensional stability and its frictional characteristics when the eccentric moves in contact with the wings of the driver (described later in the present application) and when the driver moves in contact with leaf spring (also described later in the present application) during normal use. One of skill in the art will understand alternate thermoplastic materials such as polyoxymethylene can also be employed or metallic materials such as phosphor bronze or zinc aluminum alloys. The cutter includes a toothed arrangement 72, a hole 74 and a pair of opposed cuts 76. The driver 80 includes a pair of opposed projections 86 that mate with and pass through cuts 76 of the cutter and extend into slot 58 of the lower blade. The driver includes a pin 84 that extends through hole 74 of the cutter. After the driver is mated to the cutter the head portion of the pin 74 is preferably heat staked to retain the driver to the cutter. The pin can alternatively be press fitted into the hole or adhered thereto by a suitable adhesive. The driver includes a pair of opposed wings 82 having a dimension therebetween to receive the eccentric 44.

In a well known manner of operation, as the eccentric mounted on the motor shaft rotates between the wings of the driver, this rotational motion is converted into a to and fro motion of the moving blade relative to the lower blade and the projections 86 of the driver engage and move along slot 58 of the lower blade. The total stroke of the moving blade is preferably in a range up to about 2.5 mm and most preferably about 1.8 mm. The groove is preferably straight in which case the to and fro motion is reciprocal. The groove may also follow a slight curve in which case the motion is arcuate.

A leaf spring 90 is provided to apply a spring force to maintain at least the toothed portions of the lower and moving blades in sliding contact during normal use. The leaf spring is preferably manufactured from a 301 grade stainless steel. A first end portion 92 of the leaf spring is received in a recess 18 of the housing. The recess is preferably sized to receive the end portion of the leaf spring and to substantially retain the leaf spring in combination with the housing when a user removes the lower and moving blades to clean the blades. The first end portion of the leaf spring is preferably formed into an elongated U shape having an upper leg 94 having an ultimate edge 96. When the end portion of the leaf spring is inserted into the recess of the housing, leg 94 and edge 96 act to provide a barb to retain the end portion of the leaf spring within the recess. One of skill in the art will understand that other retention means can also be employed. Referring additionally to FIG. 3A a retention means is depicted employing a suitable adhesive 102, for example a cyanoacrylate or a two-part part epoxy. In this embodiment the elongated U shape of the leaf spring can be omitted. Referring additionally to FIG. 3B the recess of the housing has a raised rib 104 that engages the leaf spring to provide a snap fit. The opposed end portion of the leaf spring is preferably provided with a shallow U shape 98. The underside apex of the shallow U acts on the driver to provide the previously mentioned spring force. The driver is further preferably provided with raised pads 87 on its upper surface. The underside apex of the shallow U is in sliding contact with these pads that are provided to reduce the contact surface area between the leaf spring and the driver.

Some trimmers have detachable blade assemblies which can be removed and reinstalled by the user so that the user may clean the blades. Many of these detachable blade assemblies include in the assembly both the respective lower and moving blades and their respective spring which necessitates a second step of disassembly by the user in order to effectively clean debris from between the blades. To be able to reuse the trimmer the user must then correctly reassemble the blade assembly before reassembling the blade assembly to the trimmer. The present application advantageously eliminates the second disassembly/assembly step by substantially retaining the spring within the housing and providing lower and moving blades that are separated upon disassembly of the lower blade. Furthermore, many blade assemblies for these trimmers have springs formed from round wire. The spring may be substantially L or U shaped. When an L shaped spring is employed, generally two springs are provided mounted mirror-wise with the short leg of the L affixed directly or indirectly to the lower blade. The end portion of the long leg of the L is in contact with and provides spring force to the moving blade. The end portion long leg of the L generally moves to and fro with the moving blade. For a to and fro moving blade movement of 2.5 mm, sufficient space must be allowed within the housing to permit each end portion to move the aforementioned 2.5 mm. When a U shaped spring is employed, generally the center portion of the U is affixed directly or indirectly to the lower blade and the end portions of each leg of the U act on the moving blade as previously described. Thus, with springs of either type a minimum clearance of 5mm must be provided to permit both end portions to unobstructedly move to and fro with the moving blade. One object of the present invention is to provide a grooming tool or a trimmer assembly in combination with a safety razor having a width ergonomically familiar to a safety razor user. By providing a spring force with a leaf spring retained in the housing that does not move to and fro with the moving blade the requirement for clearance is eliminated and the housing can be reduced in width accordingly.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. For instance, features disclosed in connection with any one embodiment can be used alone or in combination with each feature of the respective other embodiments.

What we claim is:

1. A trimmer assembly, comprising:
a trimmer housing;
a motor disposed within the trimmer housing;
a moving blade operatively connected to the motor, wherein the moving blade includes a cutter and a driver;
a lower blade removably mounted to the trimmer housing; and
a leaf spring; wherein a first end portion of the leaf spring is disposed within a recess of the trimmer housing, the recess being sized to receive the first end portion, and an opposed end portion of the leaf spring acts on the driver of the moving blade to maintain at least a toothed portion of the moving blade in sliding contact with a toothed portion of the lower blade during normal use; and
wherein the trimmer assembly is adapted to be mounted to a safety razor.

2. The trimmer of claim 1, wherein the trimmer assembly is removably mounted to the safety razor.

3. The trimmer of claim 1, wherein the trimmer housing is integrally formed with a housing of the safety razor.

4. The trimmer of claim 1, wherein the first end portion of the leaf spring includes means to retain the end portion within the recess of the trimmer housing.

5. The trimmer of claim 1, wherein the driver of the moving blade comprises a low friction material.

6. The trimmer of claim 5, wherein the low friction material is a thermoplastic.

7. The trimmer of claim 1, wherein the trimmer housing defines a width less than 25 mm.

8. The trimmer of claim 2, wherein trimmer assembly and the safety razor assembly in combination define a width less than 25 mm.

9. The trimmer of claim 3, wherein trimmer assembly and the safety razor assembly in combination define a width less than 25 mm.

10. The trimmer of claim 1, wherein the lower blade is stationary relative to the housing when the lower blade is mounted to the housing.

11. A grooming tool, comprising:
a housing;
a safety razor cartridge support assembly disposed at a first end of the housing;
a trimmer drive assembly disposed at an opposed end of the housing, comprising:
a motor;
a lower blade removably mounted to the housing;
a moving blade operatively connected to the motor, wherein the moving blade includes a cutter and a driver; and
a leaf spring; wherein a first end portion of the leaf spring is disposed within a recess of the trimmer housing, the recess being sized to receive the first end portion, and an opposed end portion of the leaf spring acts on the driver of the moving blade to maintain at least a toothed portion of the moving blade in sliding contact with a toothed portion of the lower blade during normal use.

12. The grooming tool of claim 11, wherein the housing defines a width less than 25 mm.
